(19) United States
(12) Patent Application Publication
(10) Pub. No.: US 2010/0142510 A1
(43) Pub. Date: Jun. 10, 2010

(54) COMMUNICATION APPARATUS AND METHOD FOR ENHANCING RELIABILITY IN LOW POWER TIME DIVISION ACCESS METHOD OF SENSOR NETWORK

(75) Inventors: Noseong PARK, Daejeon (KR); Yoonmee DOH, Daejeon (KR); Jong-Arm JUN, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon (KR)

(21) Appl. No.: 12/546,946

(22) Filed: Aug. 25, 2009

(30) Foreign Application Priority Data
Dec. 4, 2008 (KR) 10-2008-0122336

(51) Int. Cl. H04J 3/00

(52) U.S. Cl. 370/345

(57) ABSTRACT

Provided is a communication apparatus and method for enhancing a reliability in a low power time division access scheme of a sensor network. The communication method may include: transmitting, by a first sensor node, a Media Access Control (MAC) frame to a second sensor node in a first time slot that is allocated to the first sensor node; and receiving, by the first sensor node, a response frame with respect to the MAC frame from the second sensor node in a second time slot that is allocated to the second sensor node.

### CROSS-REFERENCE TO RELATED APPLICATION

This application claims the benefit of Korean Patent Application No. 10-2008-0122336, filed on Dec. 4, 2008, in the Korean Intellectual Property Office, the disclosure of which is incorporated herein by reference.

### BACKGROUND

1. Field of the Invention

The present invention relates to a communication apparatus and method for enhancing a reliability in a low power time division access scheme of a sensor network, and more particularly, to a communication apparatus and method that may maximize a reliability in a low power time division access scheme using an asynchronous response, a channel hopping, and a congestion control function.

2. Description of the Related Art

Generally, a sensor node constituting a sensor network may operate by a battery. In order to maximize a battery lifetime, a battery consumption may need to decrease by lowering a duty cycle. One of schemes to lower the duty cycle may be a time division access scheme of allocating a time slot for each sensor node such as an Institute of Electrical and Electronics Engineers (IEEE) 802.15.4 standard. However, the time division access scheme may not secure a completely reliable communication. Accordingly, there is a need for a communication apparatus and method that may satisfy a low power characteristic and may also maximize a reliability in a time division access scheme of a sensor network.

### SUMMARY

An aspect of the present invention provides a communication apparatus and method that may maximize a reliability in a low power time division access scheme of a sensor network using an asynchronous response, a channel hopping, and a congestion control function.

According to an aspect of the present invention, there is provided a sensor node for enhancing a reliability in a low power time division access scheme of a sensor network, the sensor node including: a transmitter to transmit a MAC frame to another sensor node in a first time slot that is allocated to the sensor node; and a receiver to receive a response frame with respect to the MAC frame from the other sensor node in a second time slot that is allocated to the other sensor node.

According to another aspect of the present invention, there is provided a communication method for enhancing a reliability in a low power time division access scheme, the method including: transmitting, by a first sensor node, a Media Access Control (MAC) frame to a second sensor node in a first time slot that is allocated to the first sensor node; and receiving, by the first sensor node, a response frame with respect to the MAC frame from the second sensor node in a second time slot that is allocated to the second sensor node.

Additional aspects, features, and/or advantages of the invention will be set forth in part in the description which follows and, in part, will be apparent from the description, or may be learned by practice of the invention.

### EFFECT

According to embodiments of the present invention, there may be provided a communication apparatus and method that may maximize a reliability in a low power time division access scheme of a sensor network using an asynchronous response, a channel hopping, and a congestion control function.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a communication apparatus for enhancing a reliability in a low power time division access scheme according to an embodiment of the present invention;

FIGS. 2 and 3 illustrate an example of transmitting and receiving a beacon and data in a sensor node according to an embodiment of the present invention;

FIG. 4 illustrates an example of allocating continuous multiple time slots to a sensor node according to an embodiment of the present invention;

FIG. 5 illustrates an example of allocating discontinuous multiple time slots to a sensor node according to an embodiment of the present invention;

FIG. 6 illustrates a diagram for describing a frequency hopping function of a communication apparatus for enhancing a reliability in a low power time division access scheme according to an embodiment of the present invention;

FIG. 7 is a flowchart illustrating a communication method of a first sensor node included in a communication apparatus for enhancing a reliability in a low power time division access scheme according to an embodiment of the present invention; and

FIG. 8 is a flowchart illustrating a communication method of a second sensor node included in a communication apparatus for enhancing a reliability in a low power time division access scheme according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

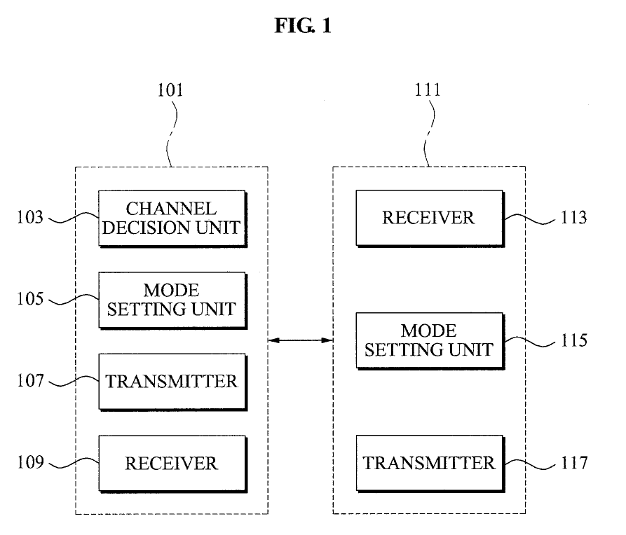

FIG. 1 is a block diagram illustrating a configuration of a communication apparatus for enhancing a reliability in a low power time division access scheme according to an embodiment of the present invention. Here, the communication apparatus may include a plurality of sensor nodes. For better comprehension and ease of description, the plurality of sensor nodes may be classified into a first sensor node 101 of a transmission side and a second sensor node 111 of a reception side. Each of the sensor nodes may transmit data in a time slot that is allocated to the corresponding sensor node.

Referring to FIG. 1, the first sensor node 101 may include a channel decision unit 103, a mode setting unit 105, a transmitter 107, and a receiver 109.

The channel decision unit 103 may determine a beacon channel for transmitting a beacon and a data channel for transmitting data, so that the beacon channel and the data channel may not overlap.

Specifically, the channel decision unit 103 may determine a starting portion of a time slot as the fixed beacon channel and determine, as the data channel, the remaining portion of the time slot excluding the beacon channel, that is, a portion of a data area. The channel decision unit 103 may determine a different data channel for each data. Also, the channel decision unit 103 may select only a stable data channel using a noise strength, and a previous transmission/reception success rate, and the like.

When there is no data to be transmitted, the mode setting unit 105 may enter a sleep mode.

The transmitter 107 may transmit a Media Access Control (MAC) frame to the second sensor node 111 in a first time slot that is allocated to the first sensor node 101.

In this instance, the transmitter 107 may transmit a beacon to the second sensor node 111 via a beacon channel of the determined first time slot, and may hop from the beacon channel to a data channel to thereby transmit data of the MAC frame to the second sensor node 111 via the data channel. Here, the beacon may include a destination address of the second sensor node 111 of the reception side, and a number of the data channel used in the data area.

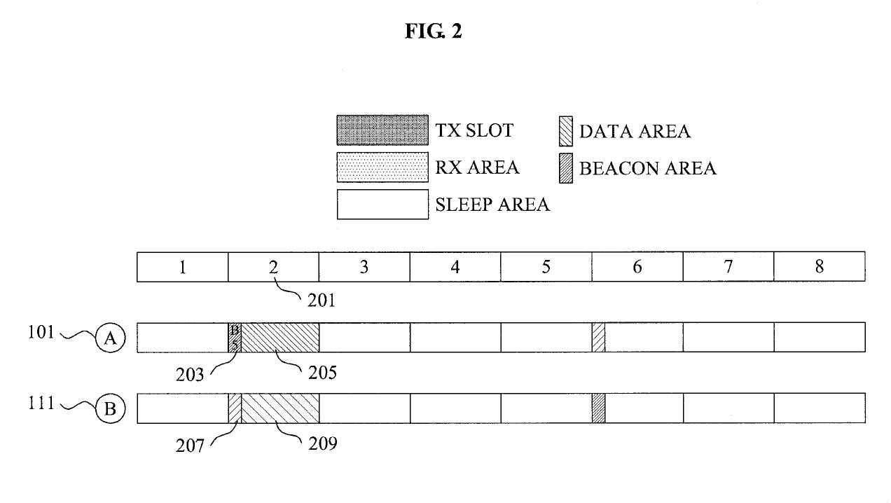

For example, as shown in FIG. 2, the transmitter 107 may transmit a beacon 203 to the second sensor node 211 via a beacon channel in a time slot (2) 201 corresponding to the first time slot allocated to the first sensor node 101. The transmitter 107 may hop from the beacon channel to a channel 5 corresponding to a data channel used in a data area 205, and transmit a MAC frame to the second sensor node 111 via the data channel. Here, the beacon 203 may include a destination address of a sensor node of a reception side, that is, the second sensor node 111 and a number of the data channel used in data areas 205 and 209, that is, ‘5’.

Referring again to FIG. 1, when a transmission success rate with respect to the transmitted data is less than or equal to a predetermined success rate, the transmitter 107 may set a multi-time mode in the beacon, and transmit the beacon and the data to the second sensor node 111 in multiple time slots. Here, the multiple time slots may include the first time slot allocated to the first sensor node 101, and an added third time slot. The third time slot may be different from the first time slot allocated to the first sensor node 101, and a second time slot allocated to the second sensor node 111.

The receiver 109 may receive response data with respect to the transmitted data from the second sensor node 111 in the second time slot that is allocated to the second sensor node 111. Here, the second time slot may be different from the first time slot that is allocated to the first sensor node 101.

The receiver 109 may receive a beacon from the second sensor node 111 via a beacon channel of the second time slot, and may hop from the beacon channel to a data channel included in the beacon to thereby receive a response frame with respect to the MAC frame from the second sensor node 111 via the data channel. Here, the response frame may include an acknowledgement (ACK) frame or a NACK frame.

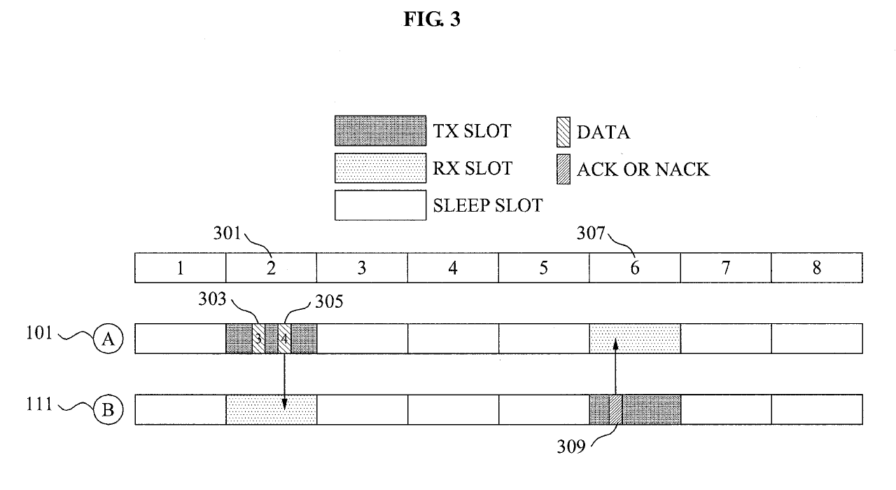

For example, as shown in FIG. 3, when the transmitter 107 transmits a first MAC frame 303 and a second MAC frame 305 in a time slot (2) 301 corresponding to the first time slot allocated to the first sensor node 101, the receiver 109 may receive a NACK frame 309 with respect to the first MAC frame 303 from the second sensor node 111 in a time slot (6) 307 corresponding to the second time slot allocated to the second sensor node 111. Here, it is assumed that the second sensor node 111 fails to receive the first MAC frame 303 and succeeds in receiving the second MAC frame 305.

When a multi-time mode is set in a received beacon, the receiver 109 may receive the beacon and data from the second sensor node 111 in multiple time slots. Here, the multiple time slots may include the second time slot allocated to the second sensor node 111 and an added third time slot. The third time slot may be different from the first time slot allocated to the first sensor node 101, and the second time slot allocated to the second sensor node 111. In this instance, the second time slot and the third time slot may be continuous or discontinuous time slots. The continuous time slots may be used as if they are a single time slot.

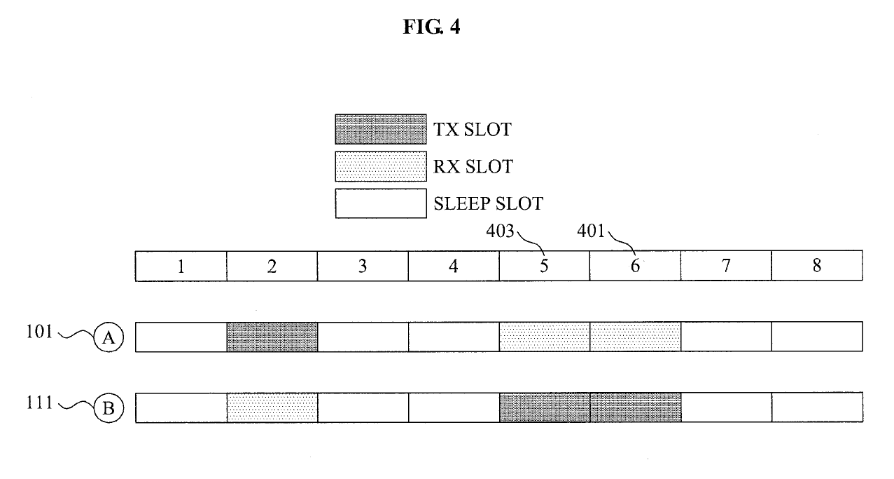

For example, as shown in FIG. 4, when a multi-time mode is set in a received beacon, the receiver 109 may receive the beacon and data from the second sensor node 111 in multiple time slots including a time slot (6) 401 that is the second time slot allocated to the second sensor node 111, and a time slot (5) 403 that is an added third time slot. Here, the time slot (5) 403 and the time slot (6) 401 of the multiple time slots are continuous and may be used as a single time slot. Accordingly, a starting portion of the time slot (5) 403 may be used as a fixed beacon channel. The remaining portion of the time slot (5) 403 excluding the beacon channel, and the time slot (6) 401 may be used as a data area.

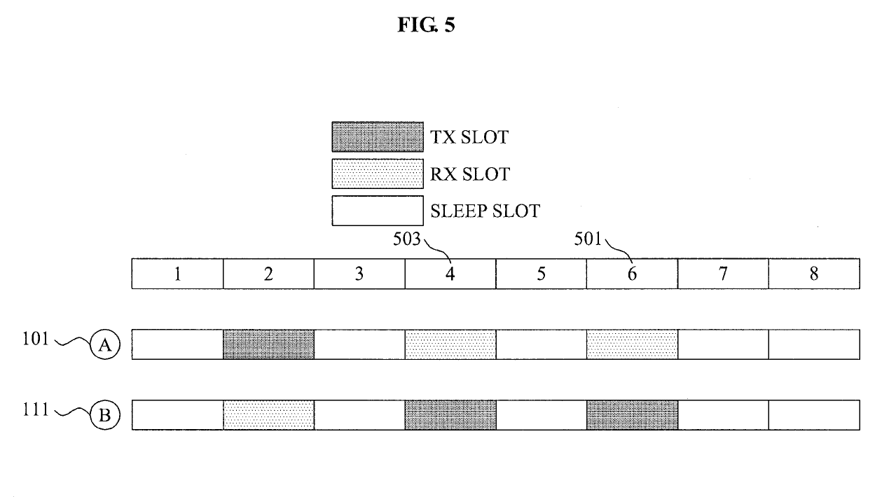

Also, as shown in FIG. 5, when a multi-time mode is set in a received beacon, the receiver 109 may receive the beacon and data from the second sensor node 111 in multiple time slots including a time slot (6) 501 that is a second time slot allocated to the second sensor node 111, and a time slot (4) 503 that is an added time slot. Here, the time slot (4) 503 and the time slot (6) 501 of the multiple time slots are discontinuous.

Referring again to FIG. 1, the second sensor node 111 may include a receiver 113, a mode setting unit 115, and a transmitter 117.

The receiver 113 may receive the MAC frame from the first sensor node 101 in the first time slot that is allocated to the first sensor node 101. In this instance, the receiver 113 may scan the first time slot and receive a beacon from the first sensor node 101 via a beacon channel that is fixed to a starting portion of the first time slot. Next, the receiver 113 may hop from the beacon channel to a data channel and receive the MAC frame from the first sensor node 101 via the data channel. Here, the receiver 113 may be aware of the data channel using a number of the data channel that is included in the received beacon.

For example, as shown in FIG. 2, the receiver 113 may receive the beacon and data from the first sensor node 101 in the time slot (2) 201 that is the first time slot allocated to the first sensor node 101. Also, the receiver 113 may receive a beacon 207 from the first sensor node 101 via the beacon channel that is fixed to the starting portion of the time slot (2) 201. Next, the receiver 113 may hop from the beacon channel to a data channel that is included in the beacon 207, that is, the channel 5, and receive the MAC frame from the first sensor node 101 via the data channel.

Also, when a multi-time mode is set in a received beacon, the receiver 113 may receive the beacon and data from the first sensor node 101 in multiple time slots. Here, the multiple time slots may include the first time slot allocated to the first sensor node 101, and an added third time slot. The third time slot may be different from the first time slot allocated to the first sensor node 101, and the second time slot allocated to the second sensor node 111.

When an address of the second sensor node 111 is not included in a destination address included in the beacon, the mode setting unit 105 may enter a sleep mode. Also, the mode setting unit 105 may recognize the existence of received data using the beacon. When no data is received, the mode setting unit 105 may enter the sleep mode.

The transmitter 117 may transmit, to the first sensor node 101, response data with respect to data that is received in the first time slot allocated to the first sensor node 101, in the second time slot allocated to the second sensor node 111. Here, the second time slot may be different from the first time slot allocated to the first sensor node 101.

The transmitter 117 may transmit a beacon to the first sensor node 101 via a beacon channel of the second time slot, hop from the beacon channel to a data channel included in the beacon, and transmit response data with respect to received data to the first sensor node 101 via the data channel.

For example, as shown in FIG. 3, when the receiver 113 receives the second MAC frame 305 in the time slot (2) 301 that is the first time slot allocated to the first sensor node 101, the transmitter 117 may transmit the NACK frame 309 with respect to the first MAC frame 303 in the time slot (6) 307 that is the second time slot allocated to the second sensor node 111. Here, it is assumed that the receiver 113 fails to receive the first MAC frame 303 and succeeds in receiving the second MAC frame 305.

When a transmission success rate with respect to transmitted data is less than or equal to a predetermined success rate, the transmitter 117 may set a multi-time mode in the beacon, and transmit the beacon and data to the first sensor node 101 in multiple time slots. Here, the multiple time slots may include the second time slot allocated to the second sensor node 111, and an added third time slot. The third time slot may be different from the first time slot allocated to the first sensor node 101, and the second time slot allocated to the second sensor node 111. In this instance, the second time slot and the third time slot may be continuous or discontinuous time slots. The continuous time slots may be used as if they are a single time slot.

In a communication apparatus for enhancing a reliability in a low power time division access scheme according to an embodiment of the present invention, a sensor node may transmit data only in a time slot allocated to the corresponding sensor node. Accordingly, when data is received in a reception time slot, the sensor node may transmit response data with respect to the received data in another allocated time slot, instead of transmitting the response data in the reception time slot. Through this, it is possible to prevent collision of data that are transmitted and are received between sensor nodes. Also, in a sensor network apparatus, a sensor node positioned around a sync node with much traffic may transmit and receive data in multiple time slots to thereby increase a number of occupied time slots and a traffic transfer rate. Through this, it is possible to solve a traffic unbalance with sensor nodes that are positioned in an end of a network with small traffic. Also, as all the sensor nodes fix a beacon channel in a starting portion of a time slot, it is possible to decrease a beacon scan time.

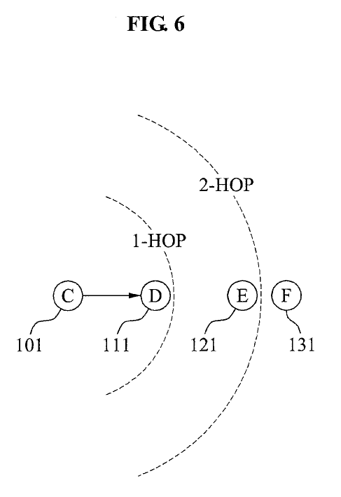

FIG. 6 illustrates a diagram for describing a frequency hopping function of a communication apparatus for enhancing a reliability in a low power time division access scheme according to an embodiment of the present invention.

Referring to FIG. 6, a network apparatus using a time division access scheme based on a 2-hop scheduling may include a first sensor node 101, a second sensor node 111, a third sensor node 121, and a fourth sensor node 131.

The first sensor node 101 may be allocated with a time slot that is different from time slots that are allocated to the second sensor node 111 and the third sensor node 121. Also, the first sensor node 101 may be allocated with the same time slot as a time slot that is allocated to the fourth sensor node 131, and may also be assigned with a different time slot. Here, the fourth sensor node 131 may be separated away from the first sensor node 101 by greater than two hops.

Even when the first sensor node 101 is allocated with the same time slot as the time slot allocated to the fourth sensor node 131 that is located around a 2-hop boundary, the first sensor node 101 may transmit data to the second sensor node 111 via a different channel from a channel of the fourth sensor node 131. Through this, the second sensor node 111 may receive data from the first sensor node 101 without interference of the fourth sensor node 131 against the data.

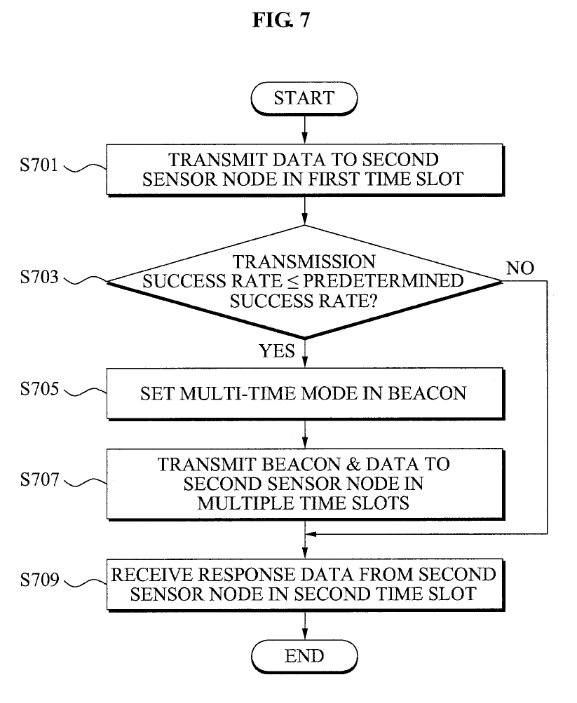

FIG. 7 is a flowchart illustrating a communication method of a first sensor node included in a communication apparatus for enhancing a reliability in a low power time division access scheme according to an embodiment of the present invention.

Referring to FIG. 7, in operation S70 1, the first sensor node may transmit data to a second sensor node in a first time slot that is allocated to the first sensor node.

Specifically, the first sensor node may determine a starting portion of the first time slot as a fixed beacon channel, and may determine the remaining portion of the first time slot excluding the beacon channel, that is, a portion of a data area, as a data channel.

Next, the first sensor node may transmit a beacon to the second sensor node via the beacon channel of the first time slot, hop from the beacon channel to the data channel, and transmit data of a MAC frame to the second sensor node via the data channel. Here, the beacon may include a destination address with respect to a sensor node of a reception side, and a number of a data channel used in the data area.

Where there is no data to be transmitted, the first sensor node may enter a sleep mode.

When a transmission success rate with respect to the transmitted data is less than or equal to a predetermined success rate in operation S703, the first sensor node may set a multi-time mode in the beacon in operation S705. In operation S707, the first sensor node may transmit the beacon and data to the second sensor node in multiple time slots.

Specifically, the first sensor node may transmit the beacon and data to the second sensor node in multiple time slots including the first time slot and an added third time slot. Here, the added third time slot may be different from the first time slot allocated to the first sensor node, and the second time slot allocated to the second sensor node.

In operation S709, the first sensor node may receive response data with respect to the received data from the second sensor node in the second time slot that is allocated to the second sensor node.

Specifically, the first sensor node may receive the beacon from the second sensor node via a beacon channel of the second time slot, hop from the beacon channel to a data channel included in the beacon, and receive a response frame with respect to a MAC frame from the second sensor node via the data channel. Here, the second time slot may be different from the first time slot allocated to the first sensor node.

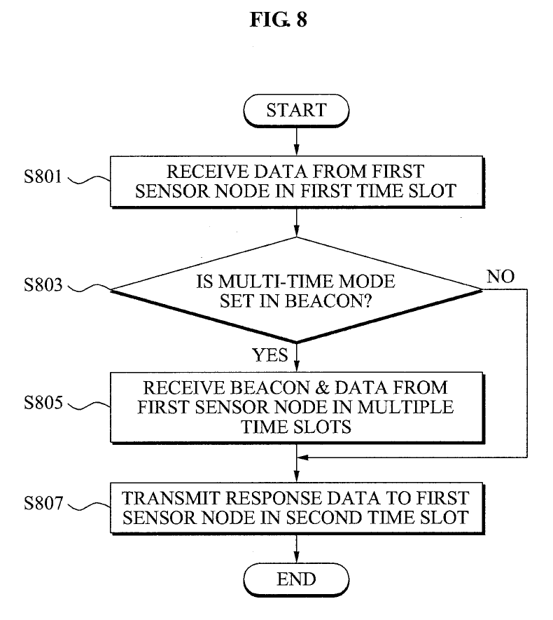

FIG. 8 is a flowchart illustrating a communication method of a second sensor node included in a communication apparatus for enhancing a reliability in a low power time division access scheme according to an embodiment of the present invention.

Referring to FIG. 8, in operation S801, the second sensor node may receive a beacon and data from a first sensor node in a first time slot that is allocated to the first sensor node.

Specifically, the second sensor node may scan the first time slot and receive the beacon via a beacon channel that is fixed in a starting portion of the first time slot. Next, the second sensor node may hop from the beacon channel to a data channel to receive a MAC frame from the first sensor node via the data channel. Here, the second sensor node may be aware of the data channel using a number of the data channel that is included in the received beacon.

When an address of the second sensor node is not included in a destination address included in the beacon, the second sensor node may enter a sleep mode. Also, the second sensor node may recognize the existence of received data using the received beacon. When no data is received, the second sensor node may enter the sleep mode.

When a multi-time mode is set in the received beacon in operation S803, the second sensor node may receive the beacon and data from the first sensor node in multiple time slots in operation S805.

Specifically, the second sensor node may receive the beacon and data from the first sensor node in the multiple time slots including the first time slot that is allocated to the first time slot, and an added third time slot. Here, the added third time slot may be different from the first time slot allocated to the first sensor node, and the second time slot allocated to the second sensor node.

In operation S807, the second sensor node may transmit response data with respect to data that is received in the first time slot allocated to the first sensor node, to the first sensor node in the second time slot allocated to the second sensor node.

Specifically, the second sensor node may transmit the beacon to the first sensor node via a beacon channel of the second time slot and hop from the beacon channel to a data channel include in the beacon. Next, the second sensor node may transmit a response frame with respect to a MAC frame to the first sensor node via the data channel. Here, the second time slot may be different from the first time slot allocated to the first sensor node.

In the aforementioned communication method for enhancing a reliability in the low power time division access scheme according to an embodiment of the present invention, each of sensor nodes may transmit data only in a time slot that is allocated to the corresponding sensor node. Accordingly, when data is received in a reception time slot, each of the sensor nodes may transmit response data with respect to the received data in another allocated time slot, instead of transmitting the response data in the reception time slot. Through this, it is possible to prevent collision of data that are transmitted and are received between sensor nodes. Also, each of the sensor nodes may use a different data channel for each data through hopping of the data channel. Accordingly, it is possible to decrease interference between the sensor nodes. Also, when there is no data to be transmitted and be received, each of the sensor nodes may enter the sleep mode to decrease a duty cycle. Through this, a battery consumption may be reduced.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A communication method for enhancing a reliability in a low power time division access scheme, the method comprising:
transmitting, by a first sensor node, a Media Access Control (MAC) frame to a second sensor node in a first time slot that is allocated to the first sensor node; and
receiving, by the first sensor node, a response frame with respect to the MAC frame from the second sensor node in a second time slot that is allocated to the second sensor node.

2. The method of claim 1, wherein the transmitting of the MAC frame comprises:
transmitting, by the first sensor node, a beacon to the second sensor node via a beacon channel of the allocated first time slot;
hopping, by the first sensor node, from the beacon channel to a data channel included in the beacon; and
transmitting, by the first sensor node, the MAC frame to the second sensor node via the data channel.

3. The method of claim 1, further comprising:
setting, by the first sensor node, a multi-time mode in a beacon to transmit the beacon and the MAC frame to the second sensor node in the first time slot and a third time slot, when a transmission success rate of the transmitted MAC frame is less than or equal to a predetermined success rate,
wherein the third time slot is different from the first time slot and the second time slot.

4. A communication method for enhancing a reliability in a low power time division access scheme, the method comprising:
receiving, by a second sensor node, a MAC frame from a first sensor node in a first time slot that is allocated to the first sensor node; and
transmitting, by the second sensor node, a response frame with respect to the MAC frame to the first sensor node in a second time slot that is allocated to the second sensor node.

5. The method of claim 4, wherein the receiving of the MAC frame comprises:
receiving, by the second sensor node, a beacon from the first sensor node via a beacon channel of the allocated first time slot;
hopping, by the second sensor node, from the beacon channel to a data channel included in the beacon; and
receiving, by the second sensor node, the MAC frame from the first sensor node via the data channel.

6. The method of claim 5, further comprising:
receiving, by the second sensor node, the beacon and the MAC frame from the first sensor node in the first time slot and a third time slot, when a multi-time mode is set in the beacon,
wherein the third time slot is different from the first time slot and the second time slot.

7. A sensor node for enhancing a reliability in a low power time division access scheme, the sensor node comprising:
a transmitter to transmit a MAC frame to another sensor node in a first time slot that is allocated to the sensor node; and
a receiver to receive a response frame with respect to the MAC frame from the other sensor node in a second time slot that is allocated to the other sensor node.

8. The sensor node of claim 7, wherein the transmitter transmits a beacon to the other sensor node via a beacon channel of the first time slot, hops from the beacon channel to a data channel included in the beacon, and transmits the MAC frame to the other sensor node via the data channel.

9. The sensor node of claim 8, further comprising:
a channel decision unit to determine the beacon channel and the data channel so that the beacon channel and the data channel do not overlap.

10. The sensor node of claim 7, wherein:
when a transmission success rate of the transmitted MAC frame is less than or equal to a predetermined success rate, the transmitter sets a multi-time mode in a beacon to transmit the beacon and the MAC frame to the other sensor node in the first time slot and a third time slot, and
the third time slot is different from the first time slot and the second time slot.

11. A sensor node for enhancing a reliability in a low power time division access scheme, the sensor node comprising:
a receiver to receive a MAC frame from another sensor node in a first time slot that is allocated to the other sensor node; and
a transmitter to transmit a response frame with respect to the MAC frame to the other sensor node in a second time slot that is allocated to the sensor node.

12. The sensor node of claim 11, wherein the receiver receives a beacon from the other sensor node via a beacon channel of the first time slot, hops from the beacon channel to a data channel included in the beacon, and receives a response frame with respect to the MAC frame from the other sensor node via the data channel.

13. The sensor node of claim 12, wherein:
when a multi-time mode is set in the beacon, the receiver receives the beacon and the MAC frame from the other sensor node in the first time slot and a third time slot, and
the third time slot is different from the first time slot and the second time slot.
